(19) United States
(12) Patent Application Publication
(10) Pub. No.: US 2026/0355670 A1
(43) Pub. Date: Nov. 12, 2026

(54) FILTRATION SYSTEM WITH ONLINE FILTER MAINTENANCE CAPABILITY

(71) Applicant: Donaldson Company, Inc., Bloomington, MN (US)

(72) Inventors: Olivier Ronneau, Chapelle-Lez-Herlaimont (BE); Thierry Capaert, Vilvoorde (BE); Wim Van Gelder, Kessel-Lo (BE)

(21) Appl. No.: 19/491,588

(22) PCT Filed: Jun. 8, 2024
(86) PCT No.: PCT/US2024/033166

§ 371 Date: Dec. 9, 2025

Related U.S. Application Data
(60) Provisional application No. 63/472,018, filed on Jun. 9, 2023.

(51) Int. Cl. B01D 46/58; B01D 46/44; B01D 46/46; B01D 46/71; G01N 15/08

(52) U.S. Cl. CPC B01D 46/58; B01D 46/442; B01D 46/446; B01D 46/46; B01D 46/71; G01N 15/08; B01D 2279/60; G01N 2015/084

(57) ABSTRACT

Embodiments herein relate to filtration systems, such as air filtration systems. In an embodiment, a filtration system can be included having a control circuit and a filter house, wherein the filter house can be divided into segregated air flow sections. The segregated air flow sections can include a first operating section, at least one further operating section, and at least one backup section. The control circuit can operate the filter system in a first and second operation mode. The first operation mode includes an air flow control system directing air flow through the first operating section and the at least one further operating section and blocking air flow through the backup section. The second operation mode includes blocking air flow through one of the first operating section and the at least one further operating section and maintaining air flow through the other operating section and the backup section.

This application is being filed as a PCT International Patent application on Jun. 7, 2024, in the name of Donaldson Company, Inc., a U.S. national corporation, applicant for the designation of all countries, and Olivier Ronneau, a Citizen of Belgium, and Thierry Capaert, a Citizen of Beguim, and Yves S. Ilboudo, a Citizen of Belgium, inventors for the designation all countries, and claims priority to U.S. Provisional Patent Application No. 63/472,018, filed Jun. 9, 2023, the contents of which are herein incorporated by reference in its entirety.

### FIELD

Embodiments herein relate to filtration systems, such as air filtration systems.

### BACKGROUND

Many systems utilizing air are benefited by filtering the incoming stream of air to remove particulate matter and/or other contaminants. For example, gas turbine systems utilize an air intake stream during operation. A gas turbine is a type of internal combustion engine that compresses air from the intake air stream and mixes it with fuel, then ignites the mixture and expands it through a turbine. Gas turbines are used for various applications including electricity generation, For electricity generation, the turbine drives a generator that produces electricity. Gas turbines can run on various types of fuels, such as natural gas, oil, coal, biomass, or hydrogen. However, particulates in the air stream utilized by a gas turbine can cause wear and/or damage and thus gas turbine air intake streams are typically filtered to remove particulates.

Systems for filtering an air or gas stream laden with particulate matter include air filter assemblies that have filter elements disposed in a housing. The filter element may be a cartridge, bag or sock of a suitable fabric or pleated paper. The accumulation of particulate materials on the filters can result in additional resistance to airflow going through the filtration system and a typically gradual increase in differential pressure drop. Therefore, differential pressure can be used to determine the relative condition of the filters as the particulate matter builds up on the filters and can be used as an indicator of when cleaning of the filters is needed. A typical cleaning system for the filter elements within dust collectors uses compressed air.

Valves are actuated and a pulse of airflows through the valves and into the interior of the filter element resulting in a retrograde pressure wave that can be sufficient to clean the filter element by dislodging particulate matter thereon. Cleaning of the filter element in this manner can cause the differential pressure to be lowered (pressure drop recovery) until further particulate matter accumulates on the filter element.

Compressed air pulses can be used for cleaning while maintaining the overall system in an operational state (on-line cleaning). However, sometimes more extensive maintenance must be performed. For example, sometimes filter elements must be replaced, sometimes valves must be replaced, or other parts must be replaced or serviced. In those cases, the system must generally be brought offline to perform the maintenance.

Some types of systems can be brought offline relatively easily and inexpensively. However, bringing a gas turbine power generation system offline for maintenance can involve a number of steps with significant downtime of the system that can be extremely costly.

### SUMMARY

Embodiments herein relate to filtration systems, such as air filtration systems. In a first aspect, a filtration system can be included having a control circuit, and a filter house, wherein the filter house can be divided into segregated air flow sections. The segregated air flow sections can include a first operating section, at least one further operating section, and at least one backup section. The filtration system can also include an air flow control system. The control circuit can be configured to operate the filter system in a first operation mode and a second operation mode. The first operation mode includes the air flow control system directing air flow through the first operating section and the at least one further operating section and blocking air flow through the at least one backup section. The second operation mode includes blocking air flow through one of the first operating section and the at least one further operating section and maintaining air flow through the other operating section and the at least one backup section.

In a second aspect, in addition to one or more of the preceding or following aspects, or in the alternative to some aspects, the air flow control system can include at least one selected from the group consisting of one or more moveable louvers, one or more air flow valves, and one or more roller shutters.

In a third aspect, in addition to one or more of the preceding or following aspects, or in the alternative to some aspects, the second operation mode can include a maintenance operation mode, wherein the maintenance operation mode can be engaged in response to receiving a maintenance initiation command and/or the filter system detecting that maintenance can be initiated or imminent for at least one operating section.

In a fourth aspect, in addition to one or more of the preceding or following aspects, or in the alterative to some aspects, the control circuit can be configured to operate the filter system in a third operation mode wherein the third operation mode includes allowing air flow through the first operating section and the at least one further operating section and the at least one backup section simultaneously.

In a fifth aspect, in addition to one or more of the preceding or following aspects, or in the alternative to some aspects, the third operation mode can be a surge capacity operation mode.

In a sixth aspect, in addition to one or more of the preceding or following aspects, or in the alterative to some aspects, the surge capacity operation mode can be engaged in response to receiving a command to increase filtration capacity and/or the filter system detecting that a pressure drop can has crossed a threshold value or can be likely to cross a threshold value.

In a seventh aspect, in addition to one or more of the preceding or following aspects, or in the alternative to some aspects, the third operation mode can include a reduced cleaning capacity operation mode, wherein the reduced cleaning capacity operation mode can be engaged in response to the system detecting that a compressed air supply has been diminished.

In an eighth aspect, in addition to one or more of the preceding or following aspects, or in the alternative to some aspects, the third operation mode can be a reduced cleaning capacity operation mode. The reduced cleaning capacity operation mode can be engaged in response to receiving a command and/or the filter system detecting that a cleaning capacity of the filter system has been diminished.

In a ninth aspect, in addition to one or more of the preceding or following aspects, or in the alterative to some aspects, the control circuit can be configured to receive a signal reflecting relative humidity.

In a tenth aspect, in addition to one or more of the preceding or following aspects, or in the alternative to some aspects, the control circuit can be configured to evaluate relative humidity in determining an operation mode to operate in.

In an eleventh aspect, in addition to one or more of the preceding or following aspects, or in the alternative to some aspects, the control circuit can be configured to engage the third operation mode when a threshold value of relative humidity has been crossed.

In a twelfth aspect, in addition to one or more of the preceding or following aspects, or in the alternative to some aspects, the filter house can include a plurality of filtration elements, wherein the plurality of filtration elements can be distributed amongst the sections of the filter house.

In a thirteenth aspect, in addition to one or more of the preceding or following aspects, or in the alternative to some aspects, the filter house can include a plurality of pulse cleaning valves, wherein the plurality of pulse cleaning valves can be distributed amongst one or more sections of the filter house.

In a fourteenth aspect, in addition to one or more of the preceding or following aspects, or in the alternative to some aspects, the system can further include a plurality of pressure sensors, wherein the plurality of pressure sensors can be configured to generate signals reflecting a pressure drop value across at least one section.

In a fifteenth aspect, in addition to one or more of the preceding or following aspects, or in the alternative to some aspects, the at least one backup section can have a maximum flow capacity that is less than the maximum flow capacity of the first operating section and the at least one further operating section individually.

In a sixteenth aspect, in addition to one or more of the preceding or following aspects, or in the alterative to some aspects, the control circuit can be configured to initiate pulse cleaning in at least one section with unblocked air flow.

In a seventeenth aspect, in addition to one or more of the preceding or following aspects, or in the alternative to some aspects, the control circuit can be configured to initiate pulse cleaning in at least one section with blocked air flow.

In an eighteenth aspect, in addition to one or more of the preceding or following aspects, or in the alternative to some aspects, the control circuit can be configured to initiate pulse cleaning in at least one section with unblocked air flow, evaluate a change in filter loading in the pulse-cleaned section, and if cleaning does not achieve a threshold value of change then block air flow in the same section and initiate pulse cleaning in the same section with the air flow now blocked.

In a nineteenth aspect, in addition to one or more of the preceding or following aspects, or in the alternative to some aspects, the filter system can be for a gas turbine system.

In a twentieth aspect, a filtration system can be included having a control circuit, and a filter house, wherein the filter house can be divided into segregated air flow sections. The segregated air flow sections can include an operating section, and at least one backup section. The filtration system can also include an air flow control system. The control circuit can be configured to operate the filter system in a first operation mode and a second operation mode. The first operation mode includes the air flow control system directing air flow through the operating section and blocking air flow through the at least one backup section. The second operation mode includes the air flow control system directing air flow through the at least one backup section and blocking air flow through the operating section.

In a twenty-first aspect, in addition to one or more of the preceding or following aspects, or in the alternative to some aspects, the air flow control system can include at least one selected from the group consisting of one or more moveable louvers, one or more air flow valves, and one or more roller shutters.

In a twenty-second aspect, in addition to one or more of the preceding or following aspects, or in the alterative to some aspects, the second operation mode can be a maintenance operation mode, wherein the maintenance operation mode can be engaged in response to receiving a maintenance initiation command and/or the filter system detecting that maintenance can be initiated or imminent for the operating section.

In a twenty-third aspect, in addition to one or more of the preceding or following aspects, or in the alternative to some aspects, the control circuit can be configured to operate the filter system in a third operation mode, wherein the third operation mode includes allowing air flow through the operating section and the at least one backup section simultaneously.

In a twenty-fourth aspect, in addition to one or more of the preceding or following aspects, or in the alternative to some aspects, the third operation mode can include a surge capacity operation mode.

In a twenty-fifth aspect, in addition to one or more of the preceding or following aspects, or in the alternative to some aspects, the surge capacity operation mode can be engaged in response to receiving a command to increase filtration capacity and/or the filter system detecting that a pressure drop can have crossed a threshold value or can be likely to cross a threshold value.

In a twenty-sixth aspect, in addition to one or more of the preceding or following aspects, or in the alternative to some aspects, the third operation mode can be a reduced cleaning capacity operation mode, wherein the reduced cleaning capacity operation mode can be engaged in response to receiving a command and/or the filter system detecting that a cleaning capacity of the filter system can have been diminished.

In a twenty-seventh aspect, in addition to one or more of the preceding or following aspects, or in the alternative to some aspects, the third operation mode can be a reduced cleaning capacity operation mode, wherein the reduced cleaning capacity operation mode can be engaged in response to the system detecting that a compressed air supply can have been diminished.

In a twenty-eighth aspect, in addition to one or more of the preceding or following aspects, or in the alternative to some aspects, the control circuit can be configured to receive a signal reflecting relative humidity.

In a twenty-ninth aspect, in addition to one or more of the preceding or following aspects, or in the alternative to some aspects, the control circuit can be configured to evaluate relative humidity in determining an operation mode to operate in.

In a thirtieth aspect, in addition to one or more of the preceding or following, aspects, or in the alternative to some aspects, the control circuit can be configured to engage the third operation mode when a threshold value of relative humidity is crossed.

In a thirty-first aspect, in addition to one or more of the preceding or following aspects, or in the alternative to some aspects, the filter house can include a plurality of filtration elements, wherein the plurality of filtration elements can be distributed amongst the sections of the filter house.

In a thirty-second aspect, in addition to one or more of the preceding or following aspects, or in the alternative to some aspects, the filter house can include a plurality of pulse cleaning valves, wherein the plurality of pulse cleaning valves can be distributed amongst one or more sections of the filter house.

In a thirty-third aspect, in addition to one or more of the preceding or following aspects, or in the alternative to some aspects, can further include a plurality of pressure sensors, wherein the plurality of pressure sensors can be configured to generate signals reflecting a pressure drop value across at least one section.

In a thirty-fourth aspect, in addition to one or more of the preceding or following aspects, or in the alternative to some aspects, the at least one backup section can have a maximum flow capacity that can be less than the operating section.

In a thirty-fifth aspect, in addition to one or more of the preceding or following aspects, or in the alternative to some aspects, the control circuit can be configured to initiate pulse cleaning in at least one section with unblocked air flow.

In a thirty-sixth aspect, in addition to one or more of the preceding or following aspects, or in the alternative to some aspects, the control circuit can be configured to initiate pulse cleaning in at least one section with blocked air flow.

In a thirty-seventh aspect, in addition to one or more of the preceding or following aspects, or in the alternative to some aspects, the control circuit can be configured to initiate pulse cleaning in at least one section with unblocked air flow, evaluate a change in filter loading in the pulse-cleaned section, and if cleaning does not achieve a threshold value of change then block air flow in the same section and initiate pulse cleaning in the same section with the air flow now blocked.

In a thirty-eighth aspect, in addition to one or more of the preceding or following aspects, or in the alternative to some aspects, the filter system can be for a gas turbine system.

In a thirty-ninth aspect, a method of operating a filtration system can be included. The method can include operating the filtration system in a first operation mode and a second operation mode. The first operation mode includes directing air flow through an operating section of the filtration system and blocking air flow through a backup section. The second operation mode includes directing air flow through the backup section of the filtration system and blocking air flow through the operating section.

In a fortieth aspect, in addition to one or more of the preceding or following aspects, or in the alternative to some aspects, the method can further include engaging the second operation mode in response to receiving a maintenance initiation command.

In a forty-first aspect, in addition to one or more of the preceding or following aspects, or in the alternative to some aspects, the method can further include engaging the second operation mode in response to detecting that maintenance is initiated or imminent for at least one operating section of the filtration system.

In a forty-second aspect, in addition to one or more of the preceding or following aspects, or in the alternative to some aspects, the method can further include operating the filtration system in a third operation mode, wherein the third operation mode includes directing air flow through the backup section of the filtration system and the operating section of the filtration system simultaneously.

In a forty-third aspect, in addition to one or more of the preceding or following aspects, or in the alternative to some aspects, the method can further include engaging the third operation mode in response to receiving a command to increase filtration capacity.

In a forty-fourth aspect, in addition to one or more of the preceding or following aspects, or in the alternative to some aspects, the method can further include engaging the third operation mode in response to detecting that a cleaning capacity of the filtration system can have been diminished.

In a forty-fifth aspect, in addition to one or more of the preceding or following aspects, or in the alternative to some aspects, the method can further include engaging the third operation mode in response to the system detecting that a compressed air supply has been diminished.

In a forty-sixth aspect, in addition to one or more of the preceding or following aspects, or in the alternative to some aspects, the method can further include engaging the third operation mode in response to detecting that a pressure drop has crossed a threshold value or is likely to cross a threshold value.

In a forty-seventh aspect, in addition to one or more of the preceding or following aspects, or in the alternative to some aspects, the method can further include engaging the third operation mode in response to detecting that a relative humidity value has crossed a threshold value or is likely to cross a threshold value.

In a forty-eighth aspect, in addition to one or more of the preceding or following aspects, or in the alternative to some aspects, the method can further include initiating pulse cleaning in at least one unblocked section.

In a forty-ninth aspect, in addition to one or more of the preceding or following aspects, or in the alternative to some aspects, the method can further include initiating pulse cleaning in at least one blocked section.

In a fiftieth aspect, in addition to one or more of the preceding or following aspects, or in the alternative to some aspects, the filtration system can be a gas turbine system.

In a fifty-first aspect, in addition to one or more of the preceding or following aspects, or in the alterative to some aspects, can further include initiating standard pulse cleaning in at least one section with unblocked air flow, evaluating a change in filter loading in the pulse-cleaned section, and blocking air flow and initiating pulse cleaning in the same section with the air flow blocked when standard cleaning does not achieve a threshold value of change.

In a fifty-second aspect, a filtration system is included having a control circuit and a filter house, wherein the filter house can be divided into segregated air flow sections. The segregated air flow sections can include a first operating section, at least one further operating section, and at least one backup section. The filtration system can also include an air flow control system. The control circuit can be configured to control the air flow control system to selectively direct air flow through the segregated sections of the filter house to temporarily block air flow through at least one segregated section and divert air flow through the at least one backup section to allow for filter maintenance to occur in the at least one segregated section without shutting down filtration operations of the filtration system.

In a fifty-third aspect, in addition to one or more of the preceding or following aspects, or in the alternative to some aspects, the air flow control system can include at least one selected from the group consisting of one or more moveable louvers, one or more air flow valves, and one or more roller shutters.

In a fifty-fourth aspect, in addition to one or more of the preceding or following aspects, or in the alternative to some aspects, the filter house can include a plurality of filtration elements, wherein the plurality of filtration elements can be distributed amongst the sections of the filter house.

In a fifty-fifth aspect, in addition to one or more of the preceding or following aspects, or in the alternative to some aspects, the filter house can include a plurality of pulse cleaning valves, wherein the plurality of pulse cleaning valves can be distributed amongst the sections of the filter house.

In a fifty-sixth aspect, in addition to one or more of the preceding or following aspects, or in the alterative to some aspects, can further include a plurality of pressure sensors, wherein the plurality of pressure sensors can be configured to generate signals reflecting a pressure drop value across at least one section.

In a fifty-seventh aspect, in addition to one or more of the preceding or following aspects, or in the alternative to some aspects, the at least one backup section can have a maximum flow capacity that can be less than the maximum flow capacity of the first operating section and the at least one further operating section individually.

In a fifty-eighth aspect, in addition to one or more of the preceding or following aspects, or in the alternative to some aspects, the control circuit can be configured to initiate pulse cleaning in at least one section with unblocked air flow.

In a fifty-ninth aspect, in addition to one or more of the preceding or following aspects, or in the alterative to some aspects, the control circuit can be configured to initiate pulse cleaning in at least one section with blocked air flow.

In a sixtieth aspect, in addition to one or more of the preceding or following aspects, or in the alternative to some aspects, the control circuit can be configured to initiate pulse cleaning in at least one section with unblocked air flow, evaluate a change in filter loading in the pulse-cleaned section, and if cleaning does not achieve a threshold value of change then block air flow in the same section and initiate pulse cleaning in the same section with the air flow now blocked.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a schematic view of filtration system in accordance with various embodiments herein.

FIG. 2 is a schematic side view of components of a filtration system in accordance with various embodiments herein.

FIG. 3 is a schematic side view of components of a filtration system in accordance with various embodiments herein.

FIG. 4 is a schematic side view of components of a filtration system in accordance with various embodiments herein.

FIG. 5 is a schematic plan view of components of a filtration system in accordance with various embodiments herein.

FIG. 6 is a block diagram of components of a control unit in accordance with various embodiments herein.

FIG. 7 is a schematic diagram of a filtration system network in accordance with various embodiments herein.

FIG. 8 is a flowchart of operations in accordance with various embodiments herein.

FIG. 9 is a flowchart of operations in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

As referenced above, air intake streams are commonly filtered to remove particulate matter and sometimes other contaminants before use in various systems. Filtration systems for air streams can include filter elements that are periodically cleaned, such as by using compressed air pulses. However, sometimes more significant cleaning, filter replacement, and/or system maintenance must be performed that generally requires system shutdown (“offline maintenance”). However, such offline maintenance can be time consuming and very costly due to the loss of productivity of the underlying system that the filtration system supports.

Embodiments herein can include filtration systems wherein system maintenance can be performed without taking the whole system offline. System maintenance can include filter maintenance, and, for example, maintenance on anything upstream of the filters such as addressing issues with inlet hoods, coalescers, etc. System maintenance can also sometimes include maintenance on components downstream from the filters. To allow system maintenance to be performed without taking the whole system offline, filtration systems herein can include segregated airflow sections (such as a first operating section, one or more further operating sections, and a backup section) that can be selectively opened and closed as a part of different operation modes. For example, during normal operation (such as a first operation mode) airflow can be directed through the first operating section and one or more further operating sections. However, in a second operation mode (such as a system maintenance mode) airflow can be blocked through one of the first operating section or one further operating section so that the blocked section can be serviced while airflow is directed through the backup section allowing the filtration system to remain operational (online) during the servicing event. In various embodiments, filtration systems herein can also operate in various other modes as described further below.

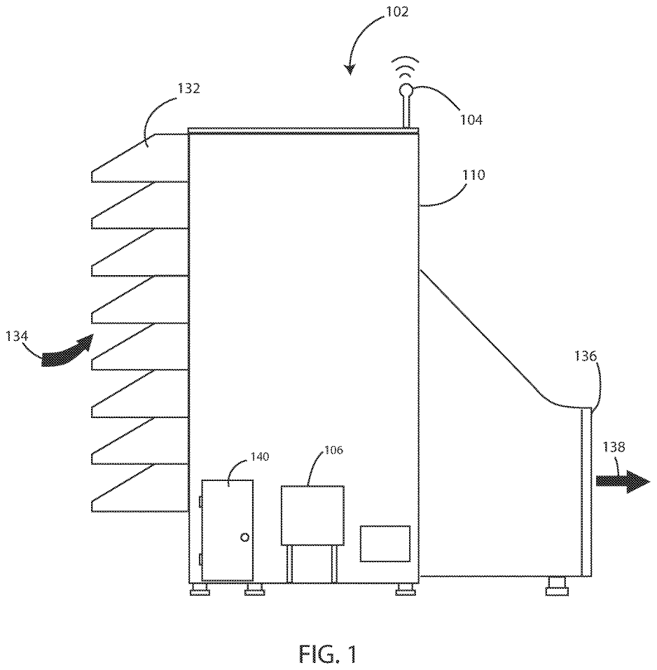

Filtration systems herein can take on many different forms and can be suitable for many different applications. Referring now to FIG. 1, a schematic view of a filtration system 102 is shown in accordance with various embodiments herein. The filtration system 102 can be a standalone unit or can be a part of various pieces of equipment. In various embodiments, the filtration system 102 can be for a gas turbine system (such as a gas turbine power generation system). However, the filtration system 102 can also be used with other types of systems utilizing air filtration such as various types of compressors, other types of rotary machines, dust collectors, and the like.

In this example, the filtration system 102 includes a filter house 110. Various components of the filtration system 102 can be housed within the filter house 110. Air inflow 134 comes in through hoods 132 (or weather hoods). The hoods 132 can be used to prevent rain, snow, or other precipitation from entering the filtration system 102. In some embodiments, the hoods 132 can include a screen or mesh to prevent leaves, sticks, branches, or other large particulates from entering the filtration system 102.

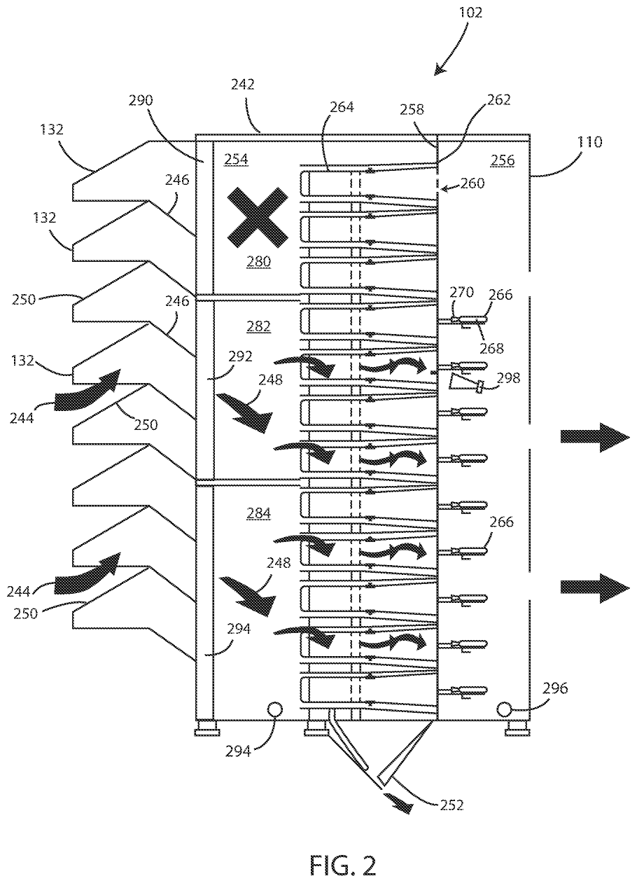

Dirty or unfiltered air can then pass through one or more filter elements (shown in FIG. 2) to remove dust or other particulates from the air. The air can then be directed out of an air outlet 136 in the direction of arrow 138. In various embodiments, the air outlet 136 can be coupled to a supply air duct that can direct the clean or supply air to a desired location of use. In other embodiments, the air outlet 136 can be directly coupled to an air inlet of a gas turbine or other equipment where the supply air is desired.

In this example, the filtration system 102 also includes a communication unit 104 and a control unit 106. The control unit 106 can be used to control operations of the filtration system 102. It will be appreciated that FIG. I is merely provided by way example and that filtration systems herein can include various other components and/or can omit some components shown in FIG. 1.

In some embodiments, the filtration system 102 can include a door 140. The door 140 can provide access to the interior of the filtration system 102, such as to allow a system user to change the filtration elements or otherwise service an interior portion of the filtration system 102.

In various embodiments, the control unit 106 (or control system) of the filtration system 102 can be configured to selectively direct airflow through segregated sections (or segments or subunits or portions) of the filter house 110. For example, in some embodiments, the control unit 106 can be configured to temporarily block airflow through at least one segregated section. In some embodiments, the control unit 106 can be configured to divert airflow through at least one backup section. In this manner, various operations can be performed (including, but not limited to system maintenance) on the blocked section while still maintaining airflow through the filtration system and/or maintaining pressure drop across the filtration system within an acceptable range to allow for filter maintenance to occur in the blocked section without shutting down filtration operations of the filtration system 102.

In various embodiments, the control unit 106 can be configured to operate the filtration system 102 in a third operation mode. The third operation mode can include allowing airflow through a first operating section and at least one further operating section and the at least one backup section simultaneously. In this manner, airflow through the filtration system 102 is increased beyond normal limits and/or pressure drop through the system can be kept lower than would otherwise be possible by utilizing the backup section or sections in addition to the normal operating section or sections.

Referring now to FIG. 2, a schematic side view of a filtration system 102 is shown in accordance with various embodiments herein. Serving as an example of a particular form of a filtration system herein, FIG. 2 shows a filtration system 102 in the form of a gas turbine air inlet filtration system. However, it is understood the filtration system 102 could be used as air filtration system for other applications as well. In addition, it will be appreciated that embodiments described herein are not limited to air intake/inlet applications, but can also include dust/particulate collector applications (cartridge based, bag based, and the like), exhaust filtration applications, etc.

In FIG. 2, unfiltered air can enter the chamber 242 through a plurality of vertically spaced hoods 132. The inlet hoods 132 can be configured such that air entering the inlet hoods 132 is first directed in an upward direction indicated by arrow 244, and then deflected by deflector plates 246 in a downward direction indicated by arrow 248. The initial upward movement of air can cause some particulate material and moisture from the air stream to settle or accumulate on lower regions 250 of the inlet hoods 132. The subsequent downward movement of air can force dust within the chamber 242 downward toward a dust collection hopper 252 located at the bottom of the chamber 242. It should also be noted that an air inlet may have vanes, screens, or other mechanical moisture separator inlets.

The chamber 242 of the filtration system 102 can be divided into an upstream volume 254 and a downstream volume 256 by a tube sheet 258 (referred to also as a “partition”). The upstream volume 254 generally represents the “dirty air section” of the filtration system 102, while the downstream volume 256 generally represents the “clean air section” of the filtration system 102. The partition 258 (or tube sheet) can define a plurality of apertures 260 allowing air to flow from the upstream volume 254 to the downstream volume 256.

The filtration system 102 can be subdivided into sections (or subunits or segments) and airflow through each section can be individually controlled. In the example of FIG. 2, at least one backup section 280 is shown along with a first operating section 282, and at least one second operating section 284. The capacities of the various sections or subunits can be the same or can be different. In various embodiments, the at least one backup section 280 has a maximum flow capacity and/or maximum filtration capacity that is less than the maximum flow capacity or maximum filtration capacity of a first operating section 282 and at least one second operating section 284 individually. However, in various embodiments, the at least one backup section 280 has a maximum flow capacity and/or maximum filtration capacity that is approximately equivalent to one or more of the operating sections individually. In some embodiments, the at least one backup section 280 has a maximum flow capacity and/or maximum filtration capacity that is greater than one or more of the operating sections individually.

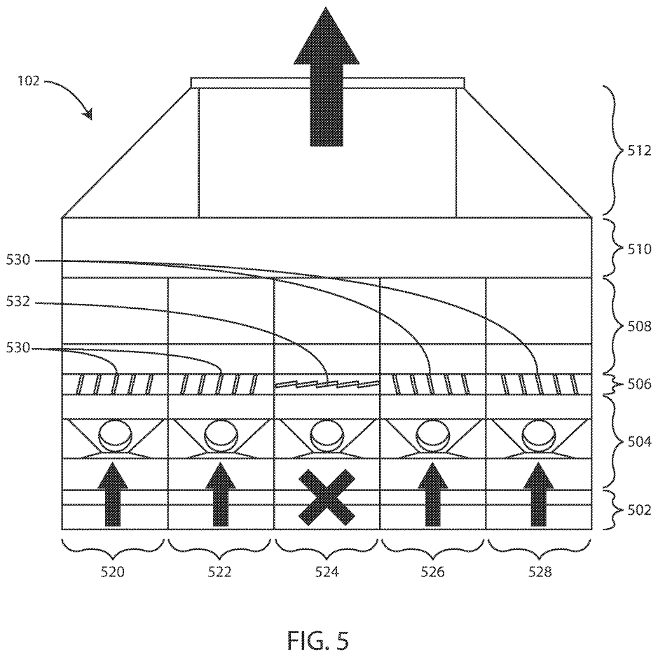

An airflow control system can be used to control airflow through the sections. The airflow control system can include components that are upstream and/or downstream from the filter elements in order to block or allow flow through the respective sections. In this example, an airflow control system includes a backup air control unit 290, a first air control unit 292, and a second air control unit 294 that are positioned upstream from the filter elements 264. However, FIG. 5 below illustrates airflow control system components downstream from the filter elements.

In various embodiments, the airflow control system components can any type of device or structure that can be used to block airflow. In some embodiments, the airflow control system components can include one or more moveable louvers, one or more airflow valves, one or more roller shutters, or the like. In some embodiments, the airflow control system can include a mechanical, electrical, electromechanical, or hydraulic actuator (such as a solenoid, electric motor, servo motor, stepper motor, hydraulic cylinder, screw jack, or the like) to move airflow control system components between a fully closed position and a fully open position (or in some cases somewhere between a fully closed position and a fully open position), The actuator can be controlled by the control unit 106 herein.

In the example of FIG. 2, the backup air control unit 290 is actuated such that airflow through the backup section 280 is blocked while airflow passes through the first operating section 282 and the second operating section 284. This can reflect a normal or default operation mode of the filtration system 102.

The filtration system 102 can include a plurality of filter element mounts 262. In this embodiment, the tube sheet 258 can be connected to a filter element mount 262. The filter element mount(s) 262 can be configured to retain or hold a filter element 264. Each aperture 260 can be covered by an air filter element 264 in the filter element mount 262 and can be located in the upstream volume 254 of the chamber 242.

In various embodiments, the filter elements 264 used with embodiments herein can include, but are not limited to, cartridge filters, bag filters, POWERCORE* brand filters, mist filters, panel filters, and the like. In some embodiments, the filter elements can have a filter medium including at least a PTFE layer or including a PTFE layer on a suitable support layer. The PTFE layer can be on the upstream side of the medium.

The filter elements 264 can be in fluid communication with the air inlet The filter elements 264 can be arranged and configured such that air flowing from the upstream volume 254 to the downstream volume 256 passes through the filter elements 264 prior to passing through the apertures 260.

In general, during filtering, air is directed from the upstream volume 254 through the filter elements 264. After being filtered, the airflows through the partition 258, via apertures 260, into the downstream clean air volume 256. The clean air is then drawn out from the downstream volume 256 and into a gas turbine intake (in the context of a gas turbine system) or into other components or areas in the context of other systems.

In various embodiments, each aperture 260 of the partition 258 includes a pulse jet air cleaner 266 mounted in the downstream volume 256. The pulse jet air cleaner 266 can include a compressed gas supply 268 and a valve 270 in fluid communication with the compressed gas supply 268. As such, the system can include a plurality of valves 270. In various embodiments, opening one or more of the plurality of valves 270 results in a pulse or pulses of a gas directed at the filter element. In some embodiments, the backup section 280 may lack pulse jet air cleaners 266. However, in other embodiments the backup section 280 can include one or more pulse jet air cleaners 266.

In some embodiments, the valve 270 can include a solenoid operated valve or a diaphragm valve. In various embodiments, the compressed gas supply 268 can include a gas supply manifold. In some embodiments, the gas supply manifold is configured to direct compressed air to each of the valves 270.

Opening the valve 270 can result in a pulse of gas directed at the filter element 264, such as to clean the filter or remove particulate build up on the dirty side of the filter. The pulse of gas can be directed at the filter element 264 in the reverse direction of normal airflow through the filter element 264, i.e. from the downstream volume 256 side of the filter element 264, such as to shake or otherwise dislodge particular material trapped in or on filter element 264.

The control unit 106 can be configured to control the valves 270, such as for compressed gas cleaning of the filter elements 264. The control circuit can be configured to initiate opening the valves 270 in response to commands, a predetermined schedule, and/or various data inputs (such as a data input indicating that a pressure drop threshold has been crossed, such as to clean the filters as an increased pressure drop across the filters can represent dirty filters). The filtration system 102 can include various sensors, such as upstream pressure sensor 295 and downstream pressure sensor 296. The sensors can be in signal communication with the control unit 106. In some embodiments, the filtration system 102 can include a number of pressure sensors that are positioned such that a pressure drop value across each section can be measured independently.

In some embodiments, such pulse cleaning can be performed on unblocked sections (sections with airflow), blocked sections (sections with airflow blocked), or both. As such, in various embodiments, the control unit 106 can be configured to initiate pulse cleaning in at least one section with unblocked airflow. In various embodiments, the control unit 106 can be configured to initiate pulse cleaning in at least one section with blocked airflow.

In some embodiments, pulse cleaning on an unblocked section (e.g., with airflow) may be less effective than pulse cleaning on a blocked section (e.g., without airflow). Therefore, in some embodiments the control circuit of the system can be configured to initiate pulse cleaning in at least one section with unblocked air flow (one or more times), then evaluate a change in filter loading in the pulse-cleaned section, and if such cleaning is not satisfactory (such as it does not achieve a threshold value of pressure drop across the filter element, or threshold value of change in pressure drop, or a threshold value or value of change in another measure of filter loading) then the system can block air flow in the same section and initiate pulse cleaning (one or more times) in the same section with the air flow now blocked. As such, in some embodiments the system can be configured to perform pulse cleaning on an unblocked section and then pulse cleaning on a blocked section in sequence.

The valves 270 can include valves having various dimensions. The valves 270 can also be of various types. In some embodiments, the valves 270 can be diaphragm type valves. However, in some embodiments, at least some valves 270 can also be a rotary valve, a rising stem valve, or a linear valve. In some embodiments, one or more valves 270 can be a solenoid valve, a coaxial valve, a butterfly valve, an angle seat valve, a ball valve, a plug valve, a gate valve, a globe valve, a needle valve, or the like.

The number of valves 270 can vary. In some embodiments, the number of valves can be greater than or equal to 2, 10, 20, 40, 60, or 80 valves. In some embodiments, the number of valves can be less than or equal to 1000, 900, 800, 700, 600, 500, 400, 300, 200, 150, 100, 80 or 60 valves. In some embodiments, the number of valves can fall within a range of 2 to 1000 valves, or 10 to 900 valves, or 20 to 800 valves, or 40 to 700 valves, or 60 to 600 valves, or 10 to 100 valves.

The number filter elements 264 within the system can also vary. In some embodiments, the number of filter elements can be greater than or equal to 2, 10, 20,40, 60, or 80 filter elements. In some embodiments, the number of filter elements can be less than or equal to 1000, 900, 800, 700, 600, 500, 400, 300, 200, 150, 100, 80 or 60 filter elements. In some embodiments, the number of filter elements can fall within a range of 2 to 1000 filter elements, or 10 to 900 filter elements, or 20 to 800 filter elements, or 40 to 700 filter elements, or 60 to 600 filter elements, or 10 to 100 filter elements.

In some embodiments, the ratio of valves to filter elements is approximately 1:1. However, in some embodiments, the ratio of valves to filter elements can be from 1:9 to 9:1, or from 1:3 to 3:1, or from 1:2 to 2:1.

In some embodiments, the filtration system may also include one or more sonic horns 298 (or sonic exciters). The sonic horn 298 can be used to provide sonic excitation to one or more of the filter elements to loosen and/or dislodge particles therefrom. The one or more sonic horns 298 can be used in combination of the valves providing pulses of air or can be used separately. The sonic horn can emit sonic energy at various frequencies. In some embodiments, the sonic horn can emit sonic energy at a human inaudible frequency, such as below 20 Hz and/or above 20 KHz. In some embodiments, the sonic horn can emit sonic energy at a frequency that is typically audible to humans, such as between 20 Hz and 20 KHz. In some particular embodiments, the sonic energy can include that in a frequency range of 60 to 250 Hz. The magnitude (or sound pressure) of the sonic energy can vary. In some embodiments, the magnitude can be measured in decibels and can be about 40 dB, 50 dB, 60 dB, 70 dB, 80 dB, 90 dB, 100 dB, 110 dB, 120 dB, 130 dB, 140 dB, 150 dB, or more, or an amount falling within a range between any of the foregoing. In addition, the waveform of the sonic energy can vary. Various types of sonic horns can be used including, for example, compressed air driven sonic horns. Sonic horns can include subcomponents including, but not limited to, a diaphragm, a driver, an air supply input, and a bell or a horn. Exemplary sonic horns are commercially available and can include those such as the MARTIN® sonic horn 230 Hz commercially available from Martin Engineering and the Model CD-70 sonic horn commercially available from Industrial Accessories Company.

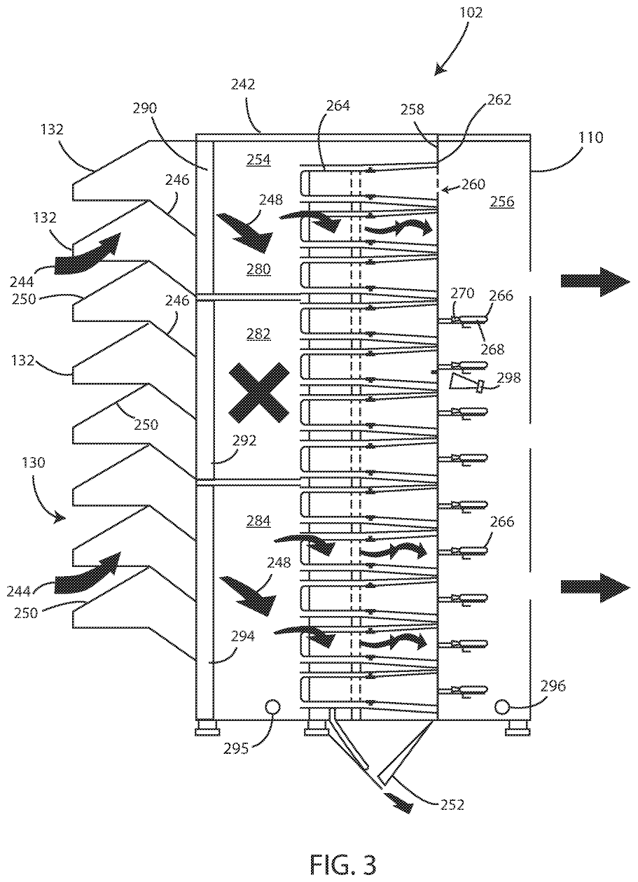

In the example of FIG. 2, the filtration system 102 is illustrated in a normal or default operation mode. However, the filtration system 102 can also be operated in various other operation modes. Referring now to FIG. 3, a schematic side view of components of a filtration system 102 is shown in accordance with various embodiments herein. FIG. 3 is generally similar to FIG. 2. As with FIG. 2, FIG. 3 includes the filtration system 102, filter house 110, hoods 132, chamber 242, deflector plates 246, lower regions 250, hopper 252, upstream volume 254, a downstream volume 256, tube sheet 258, apertures 260, filter element mounts 262, filter elements 264, pulse jet air cleaner 266, compressed gas supply 268, valves 270, sonic horn 298, upstream pressure sensor 295, downstream pressure sensor 296, and the like. Airflow follows arrows 244, and 248 into and through the filtration system 102. Further, FIG. 3 shows one backup section 280, along with a first operating section 282, and a second operating section 284. The airflow control system includes a backup air control unit 290, a first air control unit 292, and a second air control unit 294.

However, unlike in FIG. 2, FIG. 3 shows airflow blocked through the first operating section 282 and instead proceeding through the backup section 280 and the second operating section 284. As such, maintenance can be performed on the first operating section 282 (such as replacing one or more filter elements in that section or other maintenance operations) while the system remains online with the backup section 280 providing filtration capacity to makeup for the first operating section 282 being shut down. This operation mode can be engaged in response to the control unit 106 receiving a command (such as a maintenance initiation command) and/or the filtration system 102 detecting that maintenance has been initiated or is imminent for at least one operating section.

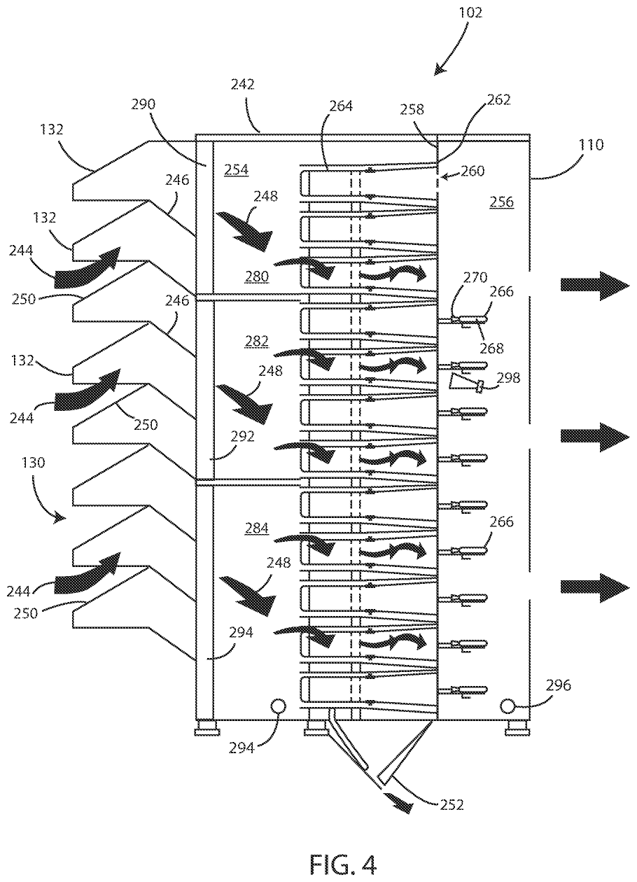

Referring now to FIG. 4, a schematic side view of components of a filtration system 102 is shown in accordance with various embodiments herein. FIG. 4 is generally similar to FIG. 2. As with FIG. 2, FIG. 4 includes the filtration system 102, filter house 110, hoods 132, chamber 242, deflector plates 246, lower regions 250, hopper 252, upstream volume 254, a downstream volume 256, tube sheet 258, apertures 260, filter element mounts 262, filter elements 264, pulse jet air cleaner 266, compressed gas supply 268, valves 270, sonic horn 298, upstream pressure sensor 295, downstream pressure sensor 296, and the like. Airflow follows arrows 244, and 248 into and through the filtration system 102. Further, FIG. 4 shows one backup section 280, along with a first operating section 282, and a second operating section 284. The airflow control system includes a backup air control unit 290, a first air control unit 292, and a second air control unit 294.

However, unlike in FIGS. 2 and 3, FIG. 4 shows airflow proceeding through all of the backup section 280, the first operating section 282, and the second operating section 284. As such, the operation mode illustrated in FIG. 4 maximizes filtration capacity of the filtration system 102 because all sections are being utilized simultaneously. The operation mode depicted in FIG. 4 can be referred to as a surge capacity operation mode or a high filtration load operation mode. In various embodiments, the surge capacity operation mode can be engaged in response to receiving a command to increase filtration capacity. In some embodiments, the operation mode depicted in FIG. 4 can be initiated based on the system detecting that a pressure drop has crossed a threshold value or is likely to cross a threshold value within the immediate future (such as within the next 30 seconds, 1 minute, 5 minutes, 10 minutes, 20 minutes, or 30 minutes). In this manner, the operation mode depicted in FIG. 4 can be used to prevent the pressure drop from increasing to a level beyond an acceptable range for the system.

In some embodiments, the operation mode depicted in FIG. 4 can be initiated based on conditions (weather conditions, environmental conditions, air conditions, etc.) being detected which are likely to increase pressure drop across the filtration system. For example, high humidity can increase pressure drop across a filtration system. In some embodiments, the system can be configured to initiate a particular operation mode, such as the operation mode depicted in FIG. 4, in response to detecting that a relative humidity value has crossed a threshold value or is likely to cross a threshold value. To facilitate such operations, in various embodiments the control unit 106 can be configured to receive a signal reflecting relative humidity. In various embodiments, the control unit 106 can be configured to evaluate relative humidity in determining an operation mode to operate in.

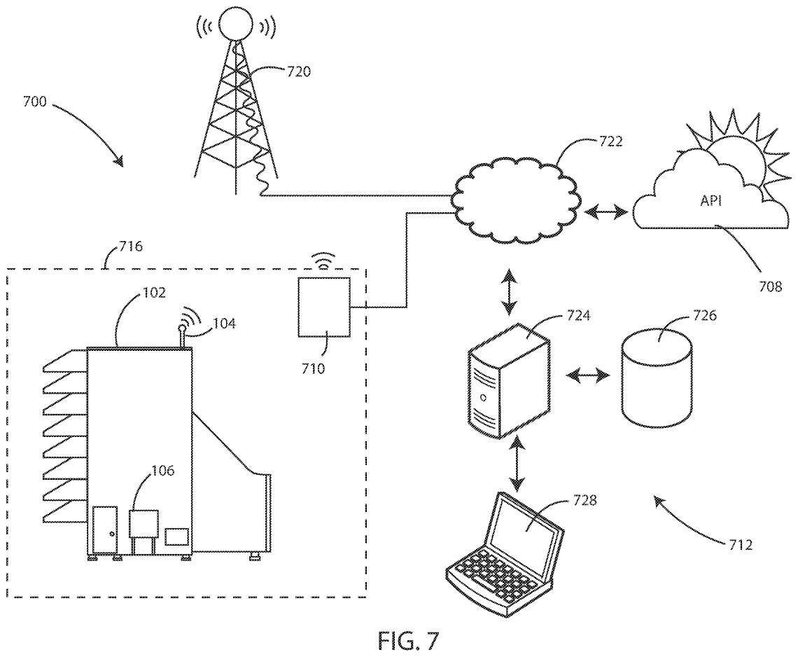

As another example, the presence of smoke or pollen may be likely to increase pressure drop across the filtration system. In some embodiments, the system can be configured to initiate a particular operation mode, such as the operation mode depicted in FIG. 4, in response to detecting that an air quality condition value (such as a smoke level, a pollen level, etc.) has crossed a threshold value or is likely to cross a threshold value. In some cases, weather conditions and/or air quality conditions can be detected using sensors that are part of the filtration system 102. In other cases, weather conditions and/or air quality conditions can be determined by receiving data from another system and/or an API (such as that described with respect to FIG. 7 below) or other data connection.

In various embodiments, the operation mode illustrated in FIG. 4 can be referred to as a reduced cleaning capacity operation mode. For example, if the system has reduced cleaning capacity (for various reasons) then the pressure drop for the filtration system may rise to unacceptably high levels. However, utilizing the additional capacity of the backup section may be sufficient to reduce the pressure drop back to acceptable levels. In various embodiments, a reduced cleaning capacity operation mode can be engaged in response to receiving a command and/or the filter system detecting that a cleaning capacity of the filter system has been diminished. In various embodiments, the reduced cleaning capacity operation mode can be engaged in response to the system detecting that a compressed air supply has been diminished.

Referring now to FIG. 5, a schematic plan view of components of a filtration system 102 in accordance with various embodiments herein. The filtration system 102 includes weather hoods 502 guiding airflow into a pulse stage 504 (or pulse cleaning stage). The pulse stage 504 can include filter elements. The filtration system 102 can also include shut-off louvers 506 serving as air control units. The shut-off louvers 506 can be actuated to move between an open position where airflow is allowed therethrough and a closed position where airflow is blocked. In this example, some of the louvers 506 are illustrated in an open position 530 and some in a closed position 532. The filtration system 102 can also include second stage 508 and evaporative cooler 510. Then airflow can pass through transition duct 512 before moving onto a system utilizing the filtered airflow, such as a gas turbine system.

The filtration system 102 can be broken up into a plurality of sections or segments so as to allow for control of airflow through individual sections or segments independently. In this example, the filtration system 102 is broken up into first section 520, second section 522, third section 524, fourth section 526, and fifth section 528. In this example, because the louvers for the third section 524 are closed, airflow is blocked through the third section 524 but is not blocked for the first section 520, second section 522, fourth section 526, and fifth section 528. Any combination of sections can be blocked. Further, any combination of sections can be open. In this example, the third section 524 can represent a backup section that is normally closed to airflow, but is opened to allow one or more other sections to be closed (such as for maintenance).

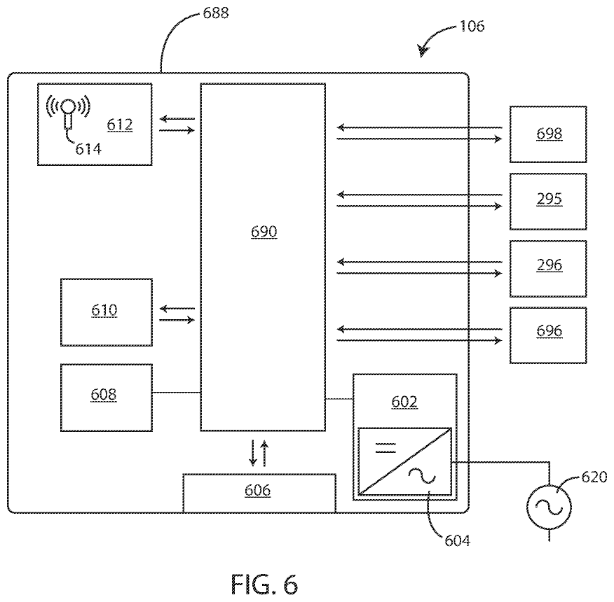

Referring now to FIG. 6, a schematic diagram is shown of elements of a control unit 106 in accordance with various embodiments herein. It will be appreciated that a greater or lesser number of components can be included with various embodiments and that this schematic diagram is merely illustrative. In this embodiment, the control unit 106 can include a housing 688 and a control circuit 690.

The control circuit 690 can include various electronic components including, but not limited to, a microprocessor, a microcontroller, a FPGA (field programmable gate array) chip, an application specific integrated circuit (ASIC), or the like.

In various embodiments, the control unit 106 can be in signal communication with pressure sensor 295 (as used herein, reference to a pressure sensor shall include a pressure transducer unless the context dictates otherwise) and pressure sensor 296. In some embodiments, pressure sensor 295 can be in fluid communication with an upstream volume or dirty air chamber and pressure sensor 296 can be in fluid communication with a downstream volume or clean air chamber, such as to measure the pressure drop across the filter elements.

In various embodiments, the control unit 106 can include a third pressure sensor 696. The third pressure sensor 696 can be in fluid communication with a compressed air manifold and/or a compressed gas supply. Various other pressure sensors can also be included.

In some embodiments, a plurality of pressure sensors can be used. For example, in some embodiments, at least one pressure sensor can be used for every filter element in the system. In some embodiments, at least one pressure sensor can be used for every zone or grouping of filter elements in the system. In some embodiments, the system can include from 2 to 1000 pressure sensors.

Pressure sensors herein can be of various types. Pressure sensors can include, but are not limited to, strain gauge type pressure sensors, capacitive type pressure sensors, piezoelectric type pressure sensors, and the like. In some embodiments, pressure sensors herein can be MEMS-based pressure sensors.

The processing power of the control circuit 690 and components thereof can be sufficient to perform various operations including various operations on data from sensors (such as pressure sensors 295, 296, and 696) including, but not limited to averaging, time-averaging, statistical analysis, normalizing, aggregating, sorting, deleting, traversing, transforming, condensing (such as eliminating selected data and/or converting the data to a less granular form), compressing (such as using a compression algorithm), merging, inserting, time-stamping, filtering, discarding outliers, calculating trends and trendlines (linear, logarithmic, polynomial, power, exponential, moving average, etc.), predicting filter element EOL (end of life), identifying an EOL condition, predicting performance, predicting costs associated with replacing filter elements vs. not-replacing filter elements, determining an appropriate operation mode, and the like.

Normalizing operations performed by the control circuit 690 can include, but are not limited to, adjusting one or more values based on another value or set of values. As just one example, pressure drop data reflective of pressure drop across a filter element can normalized by accounting for airflow rate or a value that serves as a proxy thereof.

In various embodiments the control circuit can calculate a time for replacement of a filter element and generate a signal regarding the time for replacement. In various embodiments, the control circuit can calculate a time for replacement of a filter element and issue a notification regarding the time for replacement through a user output device. In various embodiments, the control circuit can calculate a time for replacement of a filter element based on signals from the first pressure sensor and the second pressure sensor. In various embodiments, the control circuit can calculate a time for replacement of a filter element based on signals from the first pressure sensor and the second pressure sensor and an external input. The external input can be received from a system user or from a remote location through a data communication network.

In various embodiments, the control circuit can initiate a command to enter various operational modes such those described elsewhere herein. In various embodiments, the control circuit can initiate a command to switch operation modes. In various embodiments, the control circuit can initiate a command to open or close air control units so as to block or allow airflow through various filtration system sections.

In various embodiments, control circuit initiates an alarm if a predetermined alarm condition has been met. The alarm condition can include one or more a maximum value for a signal received from the first pressure sensor, a minimum value for a signal received from a pressure sensor, a maximum value for a signal received from a pressure sensor, a minimum value for a signal received from a pressure sensor, a maximum difference between a value for a signal received from one pressure sensor and a value for a signal received from another pressure sensor, and a minimum difference between a value for a signal received from one pressure sensor and a value for a signal received from another pressure sensor.

In various embodiments, the control circuit 690 can be configured to calculate a value correlated to a fluid flow rate through the filtration system based on a value provided by the upstream pressure sensor 295 and a value provided by the downstream pressure sensor 296. In some embodiments, the control circuit 690 can be configured to calculate a value correlated to a fluid flow rate through the filtration system based on a static pressure value, wherein the static pressure value by a signal from at least one of the first pressure sensor and the second pressure sensor. In some embodiments, the control circuit can be configured to calculate a value correlated to a fluid flow rate through the filtration system based on a differential pressure value and a static pressure value, wherein the differential pressure value is determined by a signal from both the upstream pressure sensor relative and the downstream pressure sensor and the static pressure value by a signal from one of the upstream and downstream pressure sensors.

In various embodiments, the control circuit 690 is configured to control actuation of the plurality of valves 270. In various embodiments, the control circuit 690 is configured to select a valve actuation pattern and execute the same such that valves are actuated in a sequence according to a determined valve actuation pattern.

In various embodiments, the control circuit 690 is configured to trigger actuation of at least one other treatment in combination with valve actuation. In various embodiments, the other treatments include sonic excitation. For example, the system can include one or more sonic horns or other devices in order to provide sonic excitation. In some embodiments, the frequency of sonic excitation can be varied in order to maximize breaking up the particulate matter on a filter (or dust cake). In some embodiments, varying of the sonic excitation frequency (or pattern of frequencies) can be performed by the system as part of an exploratory process to identify the best activation pattern.

In some embodiments, the control unit 106 can include a fourth sensor 698, such as an accelerometer, a barometric sensor, a temperature sensor, a humidity sensor, a light sensor, an optical particle detector, a particulate type sensor, a dust sensor, a flow sensor, a gas flow velocity sensor, or the like. For example, the control unit 106 can include a 3-axis accelerometer. The 3-axis accelerometer can be used to detect vibrations transmitted from or within the filtration system. The vibrations can result from various events such as periodically pulsing a brief jet of pressurized air into the interior of the filter element to reverse the airflow through the filter element and/or valve(s) opening or closing to accomplish the same. In some embodiments, the fourth sensor 698 can be used to detect the humidity or the wind speed.

In some cases, a fourth sensor 698 or additional sensor can be mounted in the housing 688. In some embodiments, an additional sensor can be mounted in the filtration system, such as in the air inlet or air outlet. In various embodiments, an additional sensor (which could be a fifth sensor, or sixth sensor, or more or less) can be mounted outside of the filtration system, such as to measure wind speed or solar light.

In various embodiments, the control unit 106 can include a power supply circuit 602. In some embodiments, the power supply circuit 602 can include various components including, but not limited to, a rectifier 604, a capacitor, a power-receiver such as a wireless power receiver, a transformer, a battery, and the like. The power supply circuit 602 can be in electrical communication with a source of power 620.

In various embodiments the control unit 106 can include an input/output device 606. The input/output device 606 can include various components for visual and/or audio output including, but not limited to, lights (such as LED lights), a display screen, a speaker, and the like. The input/output device 606 can also include components for input such as a touchscreen, a keyboard, and the like. In some embodiments, the output device can be used to provide notifications or alerts to a system user such as current system status, an indication of a problem, a required user intervention, a proper time to perform a maintenance action, or the like. In various embodiments, the input/output device 606 can be configured to receive a command from a system user regarding an operation mode to be in and/or switch to. In various embodiments, the input/output device 606 can be configured to receive an input from a system user denoting a section upon which maintenance will be performed and/or is being performed.

In various embodiments the control unit 106 can include memory 608 and/or a memory controller. The memory can include various types of memory components including dynamic RAM (D-RAM), read only memory (ROM), static RAM (S-RAM), disk storage, flash memory, EEPROM, battery-backed RAM such as S-RAM or D-RAM and any other type of digital data storage component. In some embodiments, the electronic circuit or electronic component includes volatile memory. In some embodiments, the electronic circuit or electronic component includes non-volatile memory. In some embodiments, the electronic circuit or electronic component can include transistors interconnected to provide positive feedback operating as latches or flip flops, providing for circuits that have two or more metastable states, and remain in one of these states until changed by an external input. Data storage can be based on such flip-flop containing circuits. Data storage can also be based on the storage of charge in a capacitor or on other principles. In some embodiments, the non-volatile memory 608 can be integrated with the control circuit 690.

In various embodiments the control unit 106 can include a clock circuit 610. In some embodiments, the clock circuit 610 can be integrated with the control circuit 690. While not shown in FIG. 6, it will be appreciated that various embodiments herein can include a data/communication bus to provide for the transportation of data between components. In some embodiments, an analog signal interface can be included. In some embodiments, a digital signal interface can be included.

In various embodiment the control unit 106 can include a communications circuit 612. In various embodiments, the communications circuit can include components such as an antenna 614, amplifiers, filters, digital to analog and/or analog to digital converters, and the like.

It will be appreciated that embodiments herein can be used in combination with many different types of filtration systems. Some of these filtration systems may be networked and form part of a filtration system network, while others are not networked. Referring now to FIG. 7, a schematic diagram of a filtration system network 700 is shown by way of example. A filtration system 102, such as a filtration system for a gas turbine or a manufacturing environment, can be part of the filtration system network 700 and can include a communication unit 104 and a control unit 106 or control system. The communication unit 104 can include a communication circuit, an antenna, a transceiver, and/or other components. The control unit 106 can include a control circuit, amongst other things.

In some embodiments, the filtration system 102 can be within a work environment 716. The work environment 716 can represent a geographic area in which the filtration system 102 primarily operates. In other embodiments, the work environment 716 can represent a building in which the filtration system 102 is located within. Depending on the nature of the filtration system 102, the work environment 716 can be quite large (10 s to 1000 s of square miles) or relatively small (100 s to 1000 s square feet).

In some embodiments, the work environment 716 can be, for example, a gas turbine power generation facility, a manufacturing facility, a production facility, or the like. In some embodiments, a gateway or repeater unit 710 can be disposed within the work environment 716. The gateway or repeater unit 710 can, in some embodiments, communicate wirelessly with the filtration system 102 and/or components thereof such as the communication unit 104 and/or the control unit 106. In some embodiments, the gateway or repeater unit 710 can be connected to an external data network 722, such as the Internet or various private data networks. However, in some embodiments, a gateway or repeater unit 710 can be omitted.

The control unit 106 can include a local control circuit, such as a control circuit that is located within or in close proximity to the filtration system 102. In various embodiments, the communication circuit can be in electrical communication with the local control circuit.

The filtration system 102 can also include a communication circuit as mentioned above. The communication circuit can be in electrical communication (wired or wirelessly) with the control circuit of the filtration system (or local control circuit). In some embodiments, the data communication environment can further include a remote-control and/or monitoring system 712 in communication with the filtration system 102 remotely through the data network 722. The remote-control system 712 can include a server 724 (real or virtual), a database 726 (real or virtual), and, in some embodiments, a user device output 728. In some embodiments, “remote” can refer to a component that is external to the filtration system 102. In some embodiments, “remote” can refer to a component that is outside of the work environment 716.

The control unit 106 and/or the filtration system 102 can be configured to send signals and/or data to the remote-control system 712. The remote-control system 712 can be configured to send data and/or instructions to the control unit 106 and/or the filtration system 102. In some embodiments, the remote-control system 712 can be configured to send commands to the filtration system 102 regarding what operation mode to use and/or to switch to.

In various embodiments, the remote-control system 712, the control unit 106, or the communication unit 104 can send or receive data or instructions to/from an application programming interface (API) 708, such as an air quality, environmental conditions, and/or weather API.

It will be appreciated that relevant APIs are available from a number of service providers including, but not limited to, Yahoo Weather, OpenWeatherMap, AccuWeather, Dark Sky, and the National Weather Service, amongst others. In some embodiments, the API can send information regarding past, present, or future air quality, environmental conditions, or weather conditions for the work environment 716, an area served by the filtration system 102, or an area served by a system in which the filtration system 102 is part of. In various embodiments, the API 708 can be connected to the data network 722 to communicate with other portions of the network.

In various embodiments, interface with the API can follow a SOAP or REST based architecture and can include communications in a JSON, XML, or YAML format, a derivative format based on one of these, or another data format. Communications with the API can include a request including one or more of a URL, method, headers, and a body. API responses can include one or more of status codes, headers, and a body.

In some embodiments, the data network 722 can be a packet-switched network. In some embodiments, the gateway or repeater unit 710 can also include data network router functionality. In some embodiments, wireless signals from one or more of the components such as the filtration system 102, communication unit 104, control unit 106, can be exchanged with a wireless communication tower 720 (or antenna array) directly or via the gateway or repeater unit 710. The wireless communication tower 720 can be a cellular tower or other wireless communication tower. The wireless communication tower 720 can be connected to a data network 722, such as the Internet or another type of public or private data network, packet-switched or otherwise.

The data network 722 can provide for one-way or two-way communication with other components that are external to or remote from the work environment 716. For example, a server 724 or other processing device can receive electronic signals containing data from or send electronic signals containing data to one or more components such as the filtration system 102, communication unit 104, control unit 106, gateway or repeater unit 710, or the like. The server 724 can interface with a database 726 to store data. In some embodiments, the server 724 (or a particular device that is part of the server system) can interface with a user device 728, which can allow a user to query data stored in the database 726.

Data produced and/or stored by the filtration system 102 can be of various types. In some embodiments, data produced and/or stored by the filtration system 102 can include data regarding pressure drop, time spent in different operation modes, efficacy of different operation modes, pressure drop change over time, maintenance events and/or counts of same, filter hours of usage, filter installation dates and times and/or counts of installation events, and the like.

Filtration systems herein can take on many different forms and can be those suitable for many different applications. The filtration system 102 can be a standalone unit or can be a part of various pieces of equipment. In various embodiments, the filtration system 102 is part of an industrial dust collector. In various embodiments, the filtration system 102 is part of a gas turbine power generation system.

### Methods

Many different methods are contemplated herein, including, but not limited to, methods of making, methods of using, and the like. Aspects of system/device operation described elsewhere herein can be performed as operations of one or more methods in accordance with various embodiments herein.

In various embodiments, operations described herein and method steps can be performed as part of a computer-implemented method executed by one or more processors of one or more computing devices. In various embodiments, operations described herein and method steps can be implemented instructions stored on a non-transitory, computer-readable medium that, when executed by one or more processors, cause a system to execute the operations and/or steps.

In an embodiment, a method of operating a filtration system is included. The method can include operating the filtration system in a first operation mode and a second operation mode. The first operation mode can include directing airflow through an operating section of the filtration system and blocking airflow through a backup section. The second operation mode can include directing airflow through the backup section of the filtration system and blocking airflow through the operating section.

In an embodiment, the method can further include engaging the second operation mode in response to receiving a maintenance initiation command. In an embodiment, the method can further include engaging the second operation mode in response to detecting that maintenance is initiated or imminent for at least one operating section of the filtration system. In some embodiments, the second operation mode can be engaged based on detecting that a door (such as door 140 in FIG. 1) or other access hatch for a particular section has been opened (utilizing a door or hatch sensor) and airflow through the accessed section can be shut down.

In an embodiment, the method can further include operating the filtration system in a third operation mode, wherein the third operation mode includes directing airflow through the backup section of the filtration system and the operating section of the filtration system simultaneously.

In an embodiment, the method can further include engaging the third operation mode in response to receiving a command to increase filtration capacity. In an embodiment, the method can further include engaging the third operation mode in response to detecting that a cleaning capacity of the filtration system has been diminished.

In an embodiment, the method can further include engaging the third operation mode in response to the system detecting that a compressed air supply has been diminished.

In an embodiment, the method can further include engaging the third operation mode in response to detecting that a pressure drop has crossed a threshold value or is likely to cross a threshold value.

In an embodiment, the method can further include engaging the third operation mode in response to detecting that a relative humidity value has crossed a threshold value or is likely to cross a threshold value.

In an embodiment, the method can further include initiating pulse cleaning in at least one unblocked section. In an embodiment, the method can further include initiating pulse cleaning in at least one blocked section.

In an embodiment, the method can further include initiating standard pulse cleaning in at least one section with unblocked air flow, evaluating a change in filter loading in the pulse-cleaned section, and blocking air flow and initiating pulse cleaning in the same section with the air flow blocked when standard cleaning does not achieve a desired level or threshold value of cleaning efficacy (such as a threshold value of a measure of filter loading such as pressure drop across the filter, or a threshold value of change in a measure of filter loading, etc.).

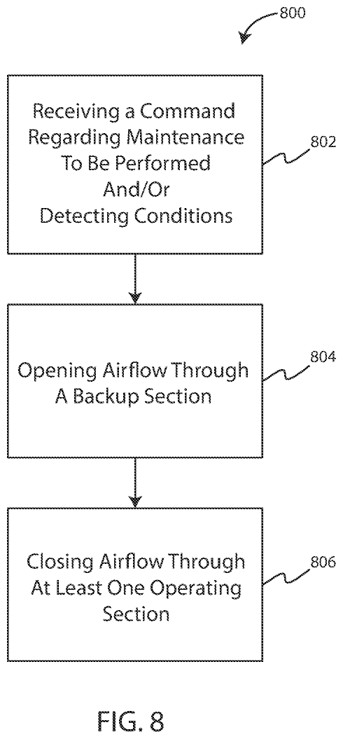

Referring now to FIG. 8, a flowchart of operations is shown in accordance with various embodiments of methods herein. The method 800 can include an operation of receiving a command regarding maintenance to be performed and/or detecting conditions 802. The method 800 can include an operation of opening airflow through a backup section 804. The method 800 can also include an operation of closing airflow through at least one operating section 806.

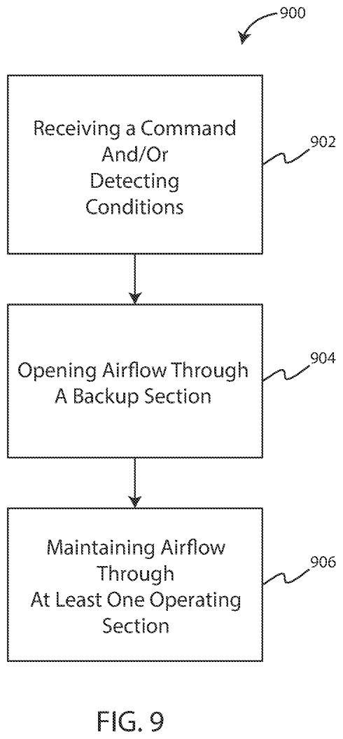

Referring now to FIG. 9, a flowchart of operations is shown in accordance with various embodiments of methods herein. The method 900 can include an operation of receiving a command and/or detecting conditions 902. The method 900 can also include an operation of opening airflow through a backup section 904. The method 900 can also include an operation of maintaining airflow through at least one operating section 906.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

The claims are:

1. A filtration system comprising:
a control circuit; and
a filter house, wherein the filter house is divided into segregated air flow sections;
the segregated air flow sections comprising
a first operating section;
at least one further operating section; and
at least one backup section;
an air flow control system;
wherein the control circuit is configured to operate the filter system in a first operation mode and a second operation mode;
wherein the first operation mode includes the air flow control system directing air flow through the first operating section and the at least one further operating section and blocking air flow through the at least one backup section; and
wherein the second operation mode includes blocking air flow through one of the first operating section and the at least one further operating section and maintaining air flow through the other operating section and the at least one backup section.

2. The filter system of any of claims 1 and 3-19, the air flow control system comprising at least one selected from the group consisting of one or more moveable louvers, one or more air flow valves, and one or more roller shutters.

3. The filter system of any of claims 1-2 and 4-19, the second operation mode comprising a maintenance operation mode, wherein the maintenance operation mode is engaged in response to receiving a maintenance initiation command and/or the filter system detecting that maintenance is initiated or imminent for at least one operating section.

4. The filter system of any of claims 1-3 and 5-19,
wherein the control circuit is configured to operate the filter system in a third operation mode; and
wherein the third operation mode includes allowing air flow through the first operating section and the at least one further operating section and the at least one backup section simultaneously.

5. The filter system of any of claims 1-4 and 6-19, the third operation mode comprising a surge capacity operation mode.

6. The filter system of any of claims 1-5 and 7-19, wherein the surge capacity operation mode is engaged in response to receiving a command to increase filtration capacity and/or the filter system detecting that a pressure drop has crossed a threshold value or is likely to cross a threshold value.

7. The filter system of any of claims 1-6 and 8-19, the third operation mode comprising a reduced cleaning capacity operation mode, wherein the reduced cleaning capacity operation mode is engaged in response to the system detecting that a compressed air supply has been diminished.

8. The filter system of any of claims 1-7 and 9-19, the third operation mode comprising a reduced cleaning capacity operation mode, wherein the reduced cleaning capacity operation mode is engaged in response to receiving a command and/or the filter system detecting that a cleaning capacity of the filter system has been diminished.

9. The filter system of any of claims 1-8 and 10-19, wherein the control circuit is configured to receive a signal reflecting relative humidity.

10. The filter system of any of claims 1-9 and 11-19, wherein the control circuit is configured to evaluate relative humidity in determining an operation mode to operate in.

11. The filter system of any of claims 1-10 and 12-19, wherein the control circuit is configured to engage the third operation mode when a threshold value of relative humidity is crossed.

12. The filter system of any of claims 1-11 and 13-19, the filter house comprising a plurality of filtration elements, wherein the plurality of filtration elements are distributed amongst the sections of the filter house.

13. The filter system of any of claims 1-12 and 14-19, the filter house comprising a plurality of pulse cleaning valves, wherein the plurality of pulse cleaning valves are distributed amongst one or more sections of the filter house.

14. The filter system of any of claims 1-13 and 15-19, further comprising a plurality of pressure sensors, wherein the plurality of pressure sensors are configured to generate signals reflecting a pressure drop value across at least one section.

15. The filter system of any of claims 1-14 and 16-19, wherein the at least one backup section has a maximum flow capacity that is less than the maximum flow capacity of the first operating section and the at least one further operating section individually.

16. The filter system of any of claims 1-15 and 17-19, wherein the control circuit is configured to initiate pulse cleaning in at least one section with unblocked air flow.

17. The filter system of any of claims 1-16 and 18-19, wherein the control circuit is configured to initiate pulse cleaning in at least one section with blocked air flow.

18. The filter system of any of claims 1-17 and 19, wherein the control circuit is configured to initiate pulse cleaning in at least one section with unblocked air flow, evaluate a change in filter loading in the pulse-cleaned section, and if cleaning does not achieve a threshold value of change then block air flow in the same section and initiate pulse cleaning in the same section with the air flow now blocked.

19. The filter system of any of claims 1-18, wherein the filter system is for a gas turbine system.

20. A filtration system comprising:
a control circuit; and
a filter house, wherein the filter house is divided into segregated air flow sections;
the segregated air flow sections comprising
an operating section; and
at least one backup section;
an air flow control system;
wherein the control circuit is configured to operate the filter system in a first operation mode and a second operation mode;
wherein the first operation mode includes the air flow control system directing air flow through the operating section and blocking air flow through the at least one backup section; and
wherein the second operation mode includes the air flow control system directing air flow through the at least one backup section and blocking air flow through the operating section.

21. The filter system of any of claims 20 and 22-38, the air flow control system comprising at least one selected from the group consisting of one or more moveable louvers, one or more air flow valves, and one or more roller shutters.

22. The filter system of any of claims 20-21 and 23-38, the second operation mode comprising a maintenance operation mode, wherein the maintenance operation mode is engaged in response to receiving a maintenance initiation command and/or the filter system detecting that maintenance is initiated or imminent for the operating section.

23. The filter system of any of claims 20-22 and 24-38,
wherein the control circuit is configured to operate the filter system in a third operation mode; and
wherein the third operation mode includes allowing air flow through the operating section and the at least one backup section simultaneously.

24. The filter system of any of claims 20-23 and 25-38, the third operation mode comprising a surge capacity operation mode.

25. The filter system of any of claims 20-24 and 26-38, wherein the surge capacity operation mode is engaged in response to receiving a command to increase filtration capacity and/or the filter system detecting that a pressure drop has crossed a threshold value or is likely to cross a threshold value.

26. The filter system of any of claims 20-25 and 27-38, the third operation mode comprising a reduced cleaning capacity operation mode, wherein the reduced cleaning capacity operation mode is engaged in response to receiving a command and/or the filter system detecting that a cleaning capacity of the filter system has been diminished.

27. The filter system of any of claims 20-26 and 28-38, the third operation mode comprising a reduced cleaning capacity operation mode, wherein the reduced cleaning capacity operation mode is engaged in response to the system detecting that a compressed air supply has been diminished.

28. The filter system of any of claims 20-27 and 29-38, wherein the control circuit is configured to receive a signal reflecting relative humidity.

29. The filter system of any of claims 20-28 and 30-38, wherein the control circuit is configured to evaluate relative humidity in determining an operation mode to operate in.

30. The filter system of any of claims 20-29 and 31-38, wherein the control circuit is configured to engage the third operation mode when a threshold value of relative humidity is crossed.

31. The filter system of any of claims 20-30 and 32-38, the filter house comprising a plurality of filtration elements, wherein the plurality of filtration elements are distributed amongst the sections of the filter house.

32. The filter system of any of claims 20-31 and 33-38, the filter house comprising a plurality of pulse cleaning valves, wherein the plurality of pulse cleaning valves are distributed amongst one or more sections of the filter house.

33. The filter system of any of claims 20-32 and 34-38, further comprising a plurality of pressure sensors, wherein the plurality of pressure sensors are configured to generate signals reflecting a pressure drop value across at least one section.

34. The filter system of any of claims 20-33 and 35-38, wherein the at least one backup section has a maximum flow capacity that is less than the operating section.

35. The filter system of any of claims 20-34 and 36-38, wherein the control circuit is configured to initiate pulse cleaning in at least one section with unblocked air flow.

36. The filter system of any of claims 20-35 and 37-38, wherein the control circuit is configured to initiate pulse cleaning in at least one section with blocked air flow.

37. The filter system of any of claims 20-36 and 38, wherein the control circuit is configured to initiate pulse cleaning in at least one section with unblocked air flow, evaluate a change in filter loading in the pulse-cleaned section, and if cleaning does not achieve a threshold value of change then block air flow in the same section and initiate pulse cleaning in the same section with the air flow now blocked.

38. The filter system of any of claims 20-37, wherein the filter system is for a gas turbine system.

39. A method of operating a filtration system comprising:
operating the filtration system in a first operation mode and a second operation mode;
wherein the first operation mode includes directing air flow through an operating section of the filtration system and blocking air flow through a backup section; and
wherein the second operation mode includes directing air flow through the backup section of the filtration system and blocking air flow through the operating section.

40. The method of any of claims 39 and 41-51, further comprising engaging the second operation mode in response to receiving a maintenance initiation command.

41. The method of any of claims 39-40 and 42-51, further comprising engaging the second operation mode in response to detecting that maintenance is initiated or imminent for at least one operating section of the filtration system,

42. The method of any of claims 39-41 and 43-51, further comprising operating the filtration system in a third operation mode, wherein the third operation mode includes directing air flow through the backup section of the filtration system and the operating section of the filtration system simultaneously.

43. The method of any of claims 39-42 and 44-51, further comprising engaging the third operation mode in response to receiving a command to increase filtration capacity.

44. The method of any of claims 39-43 and 45-51, further comprising engaging the third operation mode in response to detecting that a cleaning capacity of the filtration system has been diminished.

45. The method of any of claims 39-44 and 46-51, further comprising engaging the third operation mode in response to the system detecting that a compressed air supply has been diminished.

46. The method of any of claims 39-45 and 47-51, further comprising engaging the third operation mode in response to detecting that a pressure drop has crossed a threshold value or is likely to cross a threshold value.

47. The method of any of claims 39-46 and 48-51, further comprising engaging the third operation mode in response to detecting that a relative humidity value has crossed a threshold value or is likely to cross a threshold value.

48. The method of any of claims 39-47 and 49-51, further comprising initiating pulse cleaning in at least one unblocked section.

49. The method of any of claims 39-48 and 50-51, further comprising initiating pulse cleaning in at least one blocked section.

50. The method of any of claims 39-49 and 51, wherein the filtration system is a gas turbine system.

51. The method of any of claims 39-50, further comprising:
initiating standard pulse cleaning in at least one section with unblocked air flow;
evaluating a change in filter loading in the pulse-cleaned section; and
blocking air flow and initiating pulse cleaning in the same section with the air flow blocked when standard cleaning does not achieve a threshold value of change.

52. A filtration system comprising:
a control circuit; and
a filter house, wherein the filter house is divided into segregated air flow sections;
the segregated air flow sections comprising
a first operating section;
at least one further operating section; and
at least one backup section;
an air flow control system; and
wherein the control circuit is configured to control the air flow control system to selectively direct air flow through the segregated sections of the filter house to temporarily block air flow through at least one segregated section and divert air flow through the at least one backup section to allow for filter maintenance to occur in the at least one segregated section without shutting down filtration operations of the filtration system.

53. The filtration system of any of claims 52 and 54-60, the air flow control system comprising at least one selected from the group consisting of one or more moveable louvers, one or more air flow valves, and one or more roller shutters.

54. The filtration system of any of claims 52-53 and 55-60, the filter house comprising a plurality of filtration elements, wherein the plurality of filtration elements are distributed amongst the sections of the filter house.

55. The filtration system of any of claims 52-54 and 56-60, the filter house comprising a plurality of pulse cleaning valves, wherein the plurality of pulse cleaning valves are distributed amongst the sections of the filter house, 56. The filtration system of any of claims 52-55 and 57-60, further comprising a plurality of pressure sensors, wherein the plurality of pressure sensors are configured to generate signals reflecting a pressure drop value across at least one section.

57. The filtration system of any of claims 52-56 and 58-60, wherein the at least one backup section has a maximum flow capacity that is less than the maximum flow capacity of the first operating section and the at least one further operating section individually.

58. The filtration system of any of claims 52-57 and 59-60, wherein the control circuit is configured to initiate pulse cleaning in at least one section with unblocked air flow.

59. The filtration system of any of claims 52-58 and 60, wherein the control circuit is configured to initiate pulse cleaning in at least one section with blocked air flow.

60. The filtration system of any of claims 52-59, wherein the control circuit is configured to initiate pulse cleaning in at least one section with unblocked air flow, evaluate a change in filter loading in the pulse-cleaned section, and if cleaning does not achieve a threshold value of change then block air flow in the same section and initiate pulse cleaning in the same section with the air flow now blocked.
